(19) United States
(12) Patent Application Publication
(10) Pub. No.: US 2026/0002512 A1
(43) Pub. Date: Jan. 1, 2026

(54) METHOD OF REPOWERING A WIND TURBINE

(71) Applicant: VESTAS WIND SYSTEMS A/S, Aarhus N (DK)

(72) Inventors: Mohammed FAJAR, Hinnerup (DK); Jens Bredal NIELSEN, Struer (DK); Thomas S. Bjertrup NIELSEN, Skødstrup (DK)

(21) Appl. No.: 19/130,069

(22) PCT Filed: Dec. 11, 2023
(86) PCT No.: PCT/DK2023/050298

§ 371 Date: May 14, 2025

(30) Foreign Application Priority Data
Dec. 9, 2022 (DK) PA202270591

(51) Int. Cl. F03D 1/06; F03D 7/02; F03D 13/10

(52) U.S. Cl. CPC F03D 1/066; F03D 1/0664; F03D 7/0224; F03D 13/104; F05B 2230/60

(57) ABSTRACT

According to a first aspect of the present invention there is provided a method of repowering a horizontal-axis wind turbine The wind turbine comprises a rotor rotatably mounted to a nacelle, the rotor comprising a plurality of used first wind turbine blades connected to a hub, and each blade comprising a blade shell. Each blade extends in a radial direction from a blade root to a blade tip and in a chordwise direction between a leading edge and a trailing edge. The rotor defines a rotor axis and a first rotor diameter. The method comprises increasing the rotor diameter such that the rotor defines a second rotor diameter that is greater than the first rotor diameter. The method further comprises attaching a connecting fixture to each blade, each connecting fixture defining a connection point for connecting a blade connecting member to the blade. The method further comprises connecting a blade connecting member between corresponding connection points of a pair of wind turbine blades such that each blade is connected to at least one other blade by a blade connecting member.

### TECHNICAL FIELD

The present invention relates generally to horizontal-axis wind turbines and more particularly to a method of repowering a horizontal-axis wind turbine.

### BACKGROUND

Wind turbines have been installed in on-shore and off-shore locations for many years to generate renewable energy from the wind. As well as many smaller components, wind turbines typically include a tower, a nacelle mounted on the tower and a rotor mounted to the nacelle. The nacelle houses a drivetrain and power-generating components for converting kinetic energy into electrical energy. Each of these components of a wind turbine are designed and installed based on factors such as predicted wind conditions, predicted loading in use, and the best available technology at the time of installation.

Advances in wind turbine technology mean that new installations may be capable of capturing more energy from the wind than existing, earlier installations. However, the installation of a wind turbine, including building foundations and erecting the tower, is an expensive and time-consuming operation. In some examples it may therefore be advantageous to repower an existing wind turbine by applying new technology to the turbine to capture more energy from the wind and increase the annual energy production (AEP) of the existing turbine.

For example, new power-generating components may be exchanged for existing power-generating components in the nacelle to produce more power from the rotation of the rotor. However, uncoupling and exchanging power-generating components up-tower may be complicated or impossible, and such operations may result in significant down-time where the turbine is not generating power. In theory, increasing the diameter of the rotor increases the amount of energy captured from the wind. However, it is often not possible to increase the rotor diameter, or the increase is very limited, because longer blades experience higher blade loads, and/or because a larger rotor is typically heavier which results in increased loading of components in the hub, nacelle and/or tower.

It is against this background that the present invention has been devised.

### SUMMARY

According to a first aspect of the present invention there is provided a method of repowering a horizontal-axis wind turbine. The wind turbine comprises a rotor rotatably mounted to a nacelle, the rotor comprising a plurality of used first wind turbine blades connected to a hub, and each blade comprising a blade shell. Each blade extends in a radial direction from a blade root to a blade tip and in a chordwise direction between a leading edge and a trailing edge. The rotor defines a rotor axis and a first rotor diameter. The method comprises increasing the rotor diameter such that the rotor defines a second rotor diameter that is greater than the first rotor diameter. The method further comprises attaching a connecting fixture to each blade, each connecting fixture defining a connection point for connecting a blade connecting member to the blade. The method further comprises connecting a blade connecting member between corresponding connection points of a pair of wind turbine blades such that each blade is connected to at least one other blade by a blade connecting member.

In the present context the term ‘blade connecting member’ should be interpreted broadly to include examples such as flexible connecting members and rigid connecting members. As such, in some examples the blade connecting member may comprise a cable. Preferably the blade connecting member may therefore be a blade connecting cable, and the rotor may be a cable-stayed rotor. For example, in the present context, a ‘cable’ may be a braided or laid rope of metal wires (such as steel wires, for example), polymer fibres (such as polyethylene, polypropylene, nylon, polyester, aramid fibres, for example), inorganic fibres (such as carbon fibres, for example) or hybrid ropes of such materials. In some other examples, a blade connecting member may comprise a composite member such as a pultrusion, or alternatively a blade connecting member may comprise a rod such as a metal or polymer rod, to name a few possible examples.

Connecting a blade connecting member between corresponding connection points of a pair of wind turbine blades may comprise connecting a plurality of connecting members between corresponding connection points of a pair of blades, in some examples. For example, a plurality of blade connecting members may be connected to one another in series between corresponding connection points of a pair of wind turbine blades in some examples.

It will be appreciated that each connecting fixture is preferably a structure that is configured for transferring loads from the blade, i.e. from the blade shell, to a blade connecting member via the respective connection point.

In use, each blade connecting member connected between corresponding connection points of a pair of wind turbine blades advantageously reduces the loads experienced by a portion of the respective blade inboard of the connection point. This is because some of the blade loads are diverted to the blade connecting member instead of progressing to the hub via the inboard portion of the blade. In particular, loads may be transferred from a higher loaded blade to a lesser loaded blade via a blade connecting member in use. The blade connecting members therefore cause the wind turbine blades to mutually support each other, in the sense that loads on the wind turbine blades, in particular edgewise loads and/or flapwise loads, are ‘shared’ among the wind turbine blades, via the blade connecting members. The use of blade connecting members is particularly advantageous for reducing edgewise fatigue loads, i.e. gravity driven loads.

After repowering the wind turbine in accordance with examples of the method described herein, the wind turbine may be referred to as a repowered wind turbine. Further, following the repowering method, the rotor comprises a plurality of blades that are each connected to at least one other blade by a blade connecting member. As such, in some examples the repowered wind turbine may be described as having a cable-stayed rotor.

The method comprises attaching a connecting fixture to each blade. As such, it will be appreciated that in some examples, the method may comprise retrofitting a connecting fixture to each blade. The connecting fixture may therefore be described as an add-on system and be referred to as a retrofitted connecting fixture. For example, the connecting fixture may be retrofitted to a used blade, or to a blade comprising at least part of a used wind turbine blade which was not previously equipped with a connection point. The method according to the invention was found to be particularly advantageous when the used blade or the part of a used blade was not equipped with connection points for connecting blade connecting members in the previous use. As such, the blade was hence previously used in a conventional wind turbine without blade connecting members connecting the blades. In this case, the method including retrofitting of connecting fixtures to the blades allowed for a much larger increase in rotor diameter and hence energy production with relatively small amounts of added material and a corresponding small carbon footprint.

In some examples, the method may comprise increasing the rotor diameter by at least 10%, preferably at least 15%, or more preferably at least 20%. This may help to ensure that the rotor of the repowered wind turbine captures enough additional energy from the incident wind to make repowering the wind turbine economically advantageous.

The wind turbine blades of the rotor with increased rotor diameter may incorporate a part or the whole used blade for the same repowered wind turbine. However, it is preferred to use a used blade from another wind turbine or a new unused wind turbine blade as this allows for short shut down time during repowering of the wind turbine. The used wind turbine blade may then later be used as a whole or a part of second blade for repowering another wind turbine.

In some examples, increasing the rotor diameter may comprise extending each used first wind turbine blade in the radial direction. Alternatively, in some other examples increasing the rotor diameter may comprise providing a plurality of second wind turbine blades and exchanging each used first wind turbine blade for a second wind turbine blade. In such an example, each second wind turbine blade is preferably longer than each first wind turbine blade in the radial direction.

In some examples, extending each used first wind turbine blade in the radial direction may comprise attaching a tip extension to each first wind turbine blade. For example, the tip extension may comprise a sleeve portion shaped to fit over the tip end of the used first wind turbine blade. In some examples, attaching a tip extension to each used first wind turbine blade may therefore not involve changing the first wind turbine blade, and substantially the entire blade shell of the first wind turbine blade may remain as part of the extended blade. Alternatively, in some other examples the method may comprise removing a portion of the first wind turbine blade, i.e. a portion of the blade shell of the first wind turbine blade, before attaching the tip extension to the first wind turbine blade.

In some examples, the tip extension may be attached to the used first wind turbine blade using adhesive. Additionally or alternatively, the tip extension may be attached to the used first wind turbine blade by a mechanical connection such as a bolted connection, in some examples.

In some examples, the tip extension may have a radial length of at least 4 m, preferably at least 6 m, more preferably at least 10 m. As such, adding a tip extension to each first blade may significantly increase the swept area of the rotor such that more energy can be captured from the incident wind. In particular, adding a tip extension of at least 4 m, preferably at least 6 m, and more preferably at least 10 m, advantageously means that the cost of repowering the wind turbine can be recovered more quickly because the rotor of the repowered turbine can capture more energy from the incident wind.

In some examples, extending each used first wind turbine blade may comprise attaching a root extension to the blade root of each first blade. The method may therefore comprise reattaching each extended used first wind turbine blade to the hub via a root extension part. In some examples, the root extension part may be attached to the blade root by a bolted connection. In some examples the root extension may be connected to the hub by a bolted connection.

In examples in which the rotor diameter is increased by providing a plurality of second wind turbine blades, each second blade may comprise a second blade shell comprising an inboard shell section and an outboard shell section that are connected together. In some examples, at least part of the inboard shell section may be formed of at least part of an inboard portion of a used first blade shell. Additionally or alternatively, at least part of the outboard shell section may be formed of at least part of an outboard portion of a used first blade shell in some examples.

In some examples, at least part of the inboard shell section of each second blade shell may be formed of at least part of an inboard portion of a shell of a used third blade. Additionally or alternatively, at least part of the outboard shell section of each second blade shell may be formed of at least part of an outboard portion of a shell of a used third blade. It follows that in some examples, the second blade may be formed of a plurality of portions of shells of different used wind turbine blades, which portions of shells may or may not include used portions of shell originating from the same wind turbine.

In some examples, substantially the entire inboard shell section of each second blade shell may be formed of at least part of an inboard portion of a used first blade shell. In other examples, substantially the entire outboard shell section of each second blade shell may be formed of at least part of an outboard portion of a used first blade shell.

In some examples, the inboard shell section of each second blade shell may comprise at least 30%, preferably at least 40%, more preferably at least 50%, of the total length of the second blade.

In some examples, attaching a connecting fixture to each blade may comprise attaching the connecting fixture to both the inboard shell section and the outboard shell section of the respective second blade shell. The inboard and outboard shell sections may be connected together at a joint. Attaching a connecting fixture to each blade may therefore comprise attaching the connecting fixture to span the joint between the inboard and outboard shell sections.

In some examples, the method may further comprise assembling each second blade. Assembling each second blade may comprise attaching the inboard shell section to the outboard shell section. In some examples, the method may comprise attaching the connecting fixture to the inboard and outboard shell sections such that the inboard shell section is connected to the outboard shell section by the connecting fixture.

In some examples, increasing the rotor diameter may comprise providing a hub extender between the hub and each blade root. Each first blade may be connected to the hub at a blade-to-hub interface. Providing a hub extender between the hub and the blade root, i.e. connecting each blade to the hub via a hub extender, may therefore comprise providing the blade-to-hub interface further outboard to increase the rotor diameter.

In some examples, the connecting fixture may extend over a radial extent of between 0.5 C and 1.5 C, where C represents the chord length of the blade at the connection point. Alternatively, in some examples the connecting fixture may extend over a radial extent of between 0.01 R and 0.05 R, where R represents half of the second rotor diameter. It will be appreciated that R may be referred to as the second rotor radius. For example, the connecting fixture may extend over a radial extent of at least 2 m, and preferably over at least 3 m. Most preferably, the connecting fixture may extend over a radial extent of between 4 m and 6 m.

Attaching a connecting fixture that extends over a radial extent of between 0.5 C and 1.5 C may provide an advantageous area for transferring loads from the blade shell to the blade connecting member in use (via the connection point). Additionally, a radial extent of between 0.5 C and 1.5 C may help to facilitate the formation of a smooth outer surface of the connecting fixture to transition smoothly from an outer profile of the blade shell to reduce the drag effect of attaching a connecting fixture to the blade.

In some examples, attaching a connecting fixture to each blade may comprise bonding a connecting fixture to each blade using adhesive. For example, the method preferably comprises bonding a connecting fixture to the blade shell of each respective blade using adhesive.

In examples where a second blade comprising inboard and outboard shell sections is provided for exchanging with the used first blade as described above, the connecting fixture may be bonded to both the inboard shell section and the outboard shell section of the second blade shell using adhesive.

In some examples, attaching a connecting fixture to each blade may additionally or alternatively comprise attaching the connecting fixture to the blade using a plurality of fixing members that extend into the blade shell. In some examples, the fixing members may comprise bolts. In some examples the fixing members may comprise tapered spears. The fixing members may extend into the blade shell in a direction orthogonal to the shell surface or generally parallel to the shell surface. The fixing members may extend into and through the shell into an interior cavity of the blade in some examples. Alternatively, in some examples the fixing members may extend into, but not through, the blade shell.

In examples where a second blade comprising inboard and outboard shell sections is provided for exchanging with the used first blade as described above, the connecting fixture may be attached to the inboard shell section using one or more fixing members that extend into the inboard shell section, and the connecting fixture may be attached to the outboard shell section using one or more fixing members that extend into the outboard shell section.

In some examples, each connecting fixture may be attached to a respective blade such that the connection point is located at a radial distance of between 0.25 R to 0.55 R from the rotor axis, where R represents half of the second rotor diameter. For example, the connecting fixture may be attached to the blade such that the connection point is located at a radial distance of 20 to 40 m such as about 25 m from the rotor axis, in some examples.

Loads experienced by the root and a portion of the blade inboard of the connection point decrease with an increase in the radial distance at which the connection point is located from the rotor axis. This is because the blade connecting member can take up, i.e. divert, a greater proportion of the loads experienced by the blade if it is located further outboard. However, noise and the negative effect of drag caused by attaching the connecting fixture to the blade shell both increase with an increase in the radial distance at which the fixture is attached. Attaching the connecting fixture to the blade such that the connection point is located at a radial distance of between 0.25 R to 0.55 R from the rotor axis provides an advantageous compromise between the advantages and drawbacks of attaching a connecting fixture to the blade.

In some examples, the method may further comprise connecting a tension member between each blade connecting member and the hub. Each tension member may advantageously provide an alternative load path for transferring blade loads to the hub. Further, in some examples, the method may additionally comprise coupling a tension adjustment system between the tension member and the hub to facilitate adjustment of the tension in the tension member and associated blade connecting member. In some examples the tension adjustment system may comprise a linear actuator coupled between each respective tension member and the hub. Each linear actuator preferably has an adjustable length to facilitate tension adjustment. It will be appreciated that the length of a linear actuator refers to the distance between the points at which other wind turbine components, such as the hub and the blade connecting member or tension member for example, may be connected to the linear actuator. The repowered wind turbine may also comprise an updated control software for example introducing or modifying cyclic and/or individual pitch control as load reduction feature. Inclusion of tension members with linear actuators are particularly advantageous for the wind turbines according to the invention as these features facilitate and improve efficiency of cyclic and individual pitch control for the wind turbines.

In some examples, the method may further comprise installing one or more connectors to the hub for connecting the tension member(s) and/or actuators to the hub. Further, in some examples the method may comprise installing a support structure extending from the hub in an upwind direction. The connectors may be located on the support structure such that the connectors are located upwind of the hub.

In some examples attaching the connecting fixture to a blade may comprise overlaminating an inboard edge of the connecting fixture and/or overlaminating an outboard edge of the connecting fixture. Overlaminating one or more edges of the connecting fixture may advantageously increase the strength of the joint attaching the connection fixture to the blade. Further, the overlamination may help to provide a smooth transition between the blade shell and the connecting fixture. Accordingly, overlaminating the inboard and/or outboard edge of the connecting fixture may help to reduce the additional aerodynamic drag caused by attaching the connecting fixture to the blade.

In some examples, each connecting fixture may comprise an inner profile shaped to substantially match an outer profile of the blade shell to which the fixture is attached. This may help to ensure that in use, after the repowering method, forces and loads are distributed evenly across the joint between the connecting fixture and the blade shell, avoiding stress concentrations. Further, in some examples this may advantageously result in a consistent bondline thickness in the joint between the connecting fixture and the blade shell, which is also advantageous for transferring loads.

In some examples, each connecting fixture may be attached to the respective blade such that it extends around a leading edge of the respective blade. This may facilitate the provision of a connection point in an advantageous location on the airfoil profile of the blade, such as in a leading edge region. Further, extending around the leading edge of the blade may mean that the aerodynamic impact of the connecting fixture is reduced.

In some examples, each connecting fixture may be attached to the respective blade such that it extends around and encloses a portion of the blade shell to which the fixture is attached. For example, when viewed in cross section the connecting fixture may form a closed perimeter entirely surrounding the outer profile of the portion of the blade shell to which the connecting fixture is attached. As such the connecting fixture may be referred to as a connecting collar in some examples.

In some examples, each connecting fixture may be premanufactured prior to attachment to the blade. For example, each connecting fixture may be a laminate composite part. As such, the connecting fixture may be cured prior to attachment to the blade. In some other examples, the connecting fixture may comprise one or more metal bodies. In such an example, the connecting fixture may be shaped, for example machined, formed, or cast, into the correct configuration before the fixture is attached to the blade.

In some examples, each connecting fixture may comprise a premanufactured first part and a premanufactured second part. For example, the connecting fixture may comprise a laminate composite first part and a laminate composite second part. In such an example, the first and second parts may be cured prior to attachment to the blade. Attaching the connecting fixture to a blade may comprise sandwiching the blade shell between the first and second parts of the connecting fixture.

In some examples, the connecting fixture may be formed of a plurality of parts. The method may comprise forming the connecting fixture by joining the plurality of parts together. In preferred examples, the method may comprise overlaminating any joints between separate parts of the connecting fixture, for example using reinforcing material, to form a smooth outer surface on the connecting fixture.

In some examples, the connecting fixture may comprise a plurality of parts which, when attached to the blade to form the fixture, extend around and enclose the portion of the blade shell to which the fixture is attached. For example, the fixture, may comprise a windward part and a leeward part configured respectively for attachment to a windward side and a leeward side of the blade shell. The windward and leeward parts of the connecting fixture may meet at respective joints at the leading edge and trailing edge of the blade shell to form the connecting fixture, i.e. to form a connecting collar. In such an example, the method may comprise overlaminating the leading edge and trailing edge joints of the connecting fixture to form a smooth outer surface on the connecting fixture.

In some examples, the method may further comprise detaching each used first wind turbine blade from the hub before increasing the rotor diameter. For example, the method may comprise detaching each used first wind turbine blade from the hub up-tower. Alternatively, the method may comprise detaching the rotor from the nacelle, lowering the rotor, and subsequently detaching each used wind turbine blade from the hub. This may reduce the total time required for the repowering method, and may be particularly suitable for rotors of smaller diameters, such as rotors having a diameter of less than around 100 m.

In some preferred examples the wind turbine blades may be pitchable, i.e. rotatable, relative to the hub. For example, the wind turbine blades may each be connected to the hub via a respective pitch mechanism. As such, the rotor may be referred to as a pitchable rotor. After repowering the wind turbine in accordance with examples of the method described herein, the repowered wind turbine may be described as having a cable-stayed pitchable rotor.

In some examples, the method may further comprise arranging one or more shim angle adjustment members between the root of each blade and the blade bearing of the hub to change an in-plane inclination and/or out-of-plane inclination of each blade. The in-plane inclination may be measured between a theoretical centreline of the blade and a pitch axis of the blade in a plane parallel to the rotor plane. The out-of-plane inclination of each blade may be measured between the theoretical centreline of the blade and the pitch axis in a plane perpendicular to the rotor plane. As used herein, the theoretical centre line of the blade connects a centre point of the blade root and a blade centre at the radial location of the connection point. The blade centre is defined as the intersection of the chord between the leading and trailing edges and a thickness line orthogonal to the chord at the maximum thickness, at the given radial location.

In some examples, the wind turbine may further comprise a controller. In such an example, the method may further comprise upgrading the controller with one or more revised control functions to effect at least one of the following, a) reduce the rated rotational speed of the rotor, b) reduce the rated power of the wind turbine, c) modify the pitch control to limit the maximum thrust on the wind turbine and/or to limit flapwise blade loads, d) reduce the stop wind speed, e) modify pitch control by introducing or modifying cyclic and/or individual pitch control as load reduction feature. It should be understood that the rated rotational speed of the rotor is the mean of the maximum rotor speed. Additionally, modifying the pitch control may involve reducing wind speed thresholds at which blade pitch control is initiated. Furthermore, the updated control software may for example introducing or modifying cyclic and/or individual pitch control as load reduction feature. Inclusion of tension members with linear actuators are particularly advantageous for the wind turbines according to the invention as these features may facilitate and improve efficiency of cyclic and individual pitch control for the wind turbines.

Upgrading the controller as described above may advantageously facilitate reuse of the main turbine parts, such as the generator, main bearing, pitch mechanisms, yaw system, tower and gearbox (if present), for the repowered wind turbine. For example, the wind turbine may be repowered and may not require changes to other turbine parts except the rotor, as described in the examples. In other examples however some of the main turbine parts are modified or exchanged in combination with repowering the wind turbine. This may for instance be the blade bearings, pitch system, gearbox (if present), generator or convertor.

According to another aspect of the present invention there is provided a horizontal-axis wind turbine repowered in accordance with any of the examples of the method described above. The repowered horizontal-axis wind turbine comprises a rotor rotatably mounted to a nacelle. The rotor comprises a plurality of wind turbine blades connected to a hub. Each blade comprises a blade shell, and each blade extends in a radial direction from a blade root to a blade tip. The repowered wind turbine further comprises a connecting fixture attached to each blade. Each connecting fixture defines a connection point for connecting a blade connecting member to the blade. The repowered wind turbine further comprises a plurality of blade connecting members. Each blade connecting member is connected between corresponding connection points of a pair of wind turbine blades such that each blade is connected to at least one other blade by a blade connecting member.

### BRIEF DESCRIPTION OF THE DRAWINGS

Examples of the present invention will now be described by way of non-limiting example only, with reference to the accompanying figures, in which:

FIG. 1 is a schematic perspective view of an existing wind turbine;

FIG. 2 is a schematic perspective view of a repowered wind turbine comprising a rotor having an increased diameter compared to the existing turbine;

FIG. 3a is a schematic plan view of a wind turbine blade of the repowered wind turbine comprising a tip extension;

FIG. 3b is a schematic plan view of a wind turbine blade of the repowered wind turbine comprising a root extension;

FIG. 4 is a schematic plan view of a second blade for exchanging with a used first blade of the existing wind turbine;

FIG. 5 is a schematic plan view of a blade of the repowered wind turbine comprising a connecting fixture attached to the blade to provide a connection point;

FIG. 6 is a schematic cross-sectional view of the blade at the connection point; and

FIG. 7 is a schematic cross-sectional view of a portion of a shell of the blade and overlaminated edges of the connecting fixture.

### DETAILED DESCRIPTION

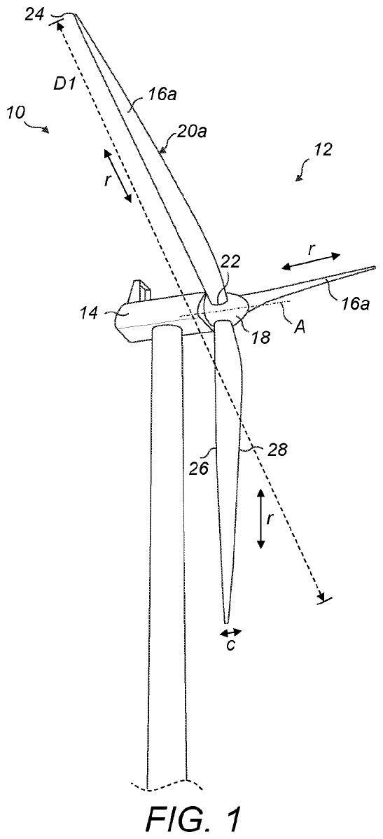

FIG. 1 shows a schematic perspective view of a used wind turbine 10 installed at a wind turbine site. The wind turbine 10 comprises a rotor 12 which is rotatably mounted to a nacelle 14 of the turbine 10. The nacelle 14 typically houses power generation components of the turbine 10, such as a generator and optionally a gearbox, in some examples. The rotor 12 may be mounted to the nacelle 14 via a main bearing (not shown). The rotor 12 defines a rotor axis A about which it rotates. The rotor axis A is substantially horizontal, and the turbine 10 may therefore be referred to as a horizontal-axis wind turbine 10.

The rotor 12 comprises a plurality of first wind turbine blades 16a connected to a hub 18. In some preferred examples the first wind turbine blades 16a may each be connected to the hub 18 via a respective pitch mechanism (not shown). Accordingly, the first wind turbine blades 16a may be pitchable, i.e. rotatable, relative to the hub 18, and the rotor 12 may therefore be referred to as a pitchable rotor 12.

The wind turbine 10 in FIG. 1 is a used wind turbine, and accordingly the first wind turbine blades 16a are used wind turbine blades. Each blade 16a comprises a blade shell 20a, and each blade shell 20a preferably defines an aerodynamic profile shaped to extract energy from wind incident on the blade 16a in use. Each blade 16a extends from a blade root 22 to a blade tip 24 in a radial direction r, and between a leading edge 26 and a trailing edge 28 in a chordwise direction c. As indicated in FIG. 1, the rotor 12 of the existing turbine 10, including the used first blades 16a, defines a first rotor diameter D1.

As described by way of background above, following installation and use of the existing wind turbine 10, new technology has been developed such that it is now possible to upgrade the existing, installed wind turbine 10 and produce more power. As will now be described with reference to the remaining figures, the existing wind turbine 10 can be repowered in accordance with examples of the method described herein to increase the annual energy production (AEP) of the turbine 10.

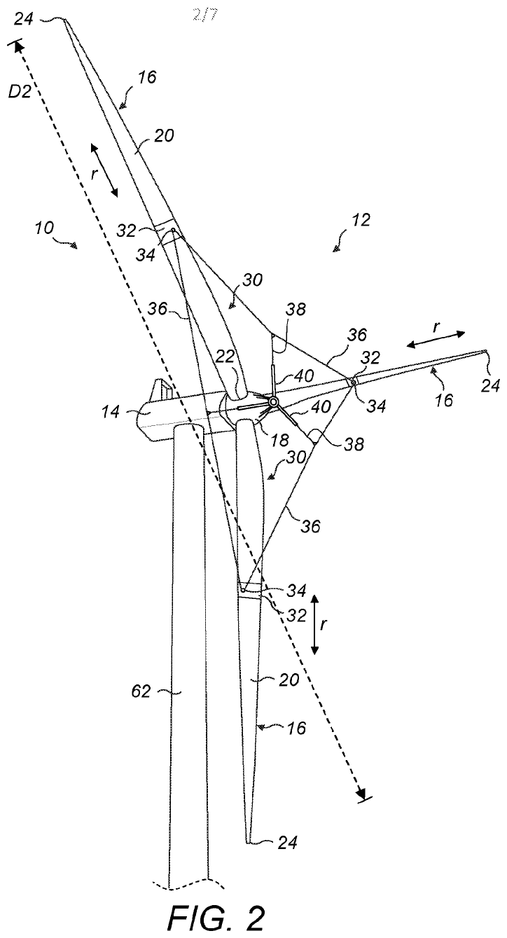

FIG. 2 shows a schematic perspective view of an example of the resulting wind turbine 10 after the turbine has been repowered in accordance with an example of the method. Following the repowering method, the wind turbine 10 may be referred to as a repowered wind turbine 10. The method of repowering will be described generally with reference to FIG. 2, and further examples of the repowering method will be described subsequently with reference to the remaining figures.

As is evident from the repowered wind turbine 10 shown in the example of FIG. 2, the repowering method includes increasing the rotor diameter. Accordingly, the repowered wind turbine 10 comprises a rotor 12 having a second rotor diameter D2 that is greater than the first rotor diameter D1. As described by way of background, increasing the diameter of the rotor 12 increases the amount of energy that the wind turbine 10 can capture from the incident wind. Accordingly, increasing the rotor diameter helps to increase the annual energy production (AEP) of the turbine 10.

However, as rotor diameter increases, the loads experienced in use by the blades 16 also increases. In particular, respective inboard portions 30 of blades 16 of a larger-diameter rotor 12 experience greater loads because of the increased weight and moment forces resulting from the increased rotor diameter. Accordingly, the repowering method includes assembling a plurality of additional components to overcome the challenges associated with increasing the rotor diameter.

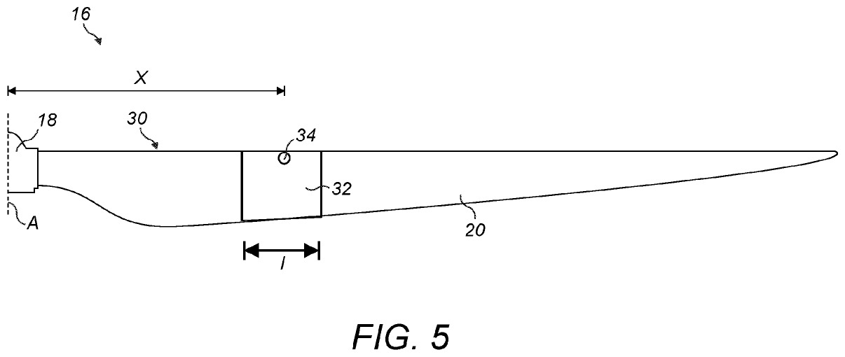

Still with reference to FIG. 2, the repowering method therefore includes attaching a connecting fixture 32 to each blade 16. Examples of a connecting fixture 32 will be described later in more detail with reference to FIGS. 5 to 7. However, primarily, each connecting fixture 32 defines a connection point 34 for connecting a blade connecting member 36 to the blade 16. It follows that the repowering method also includes connecting a blade connecting member 36 between corresponding connection points 34 of a pair of wind turbine blades 16. As shown in FIG. 2, each blade 16 of the repowered wind turbine 10 is therefore connected to at least one other blade 16 by a blade connecting member 36.

In use, each blade connecting member 36 connected between corresponding connection points 34 of a pair of wind turbine blades 16 advantageously reduces the loads experienced by the portion of the respective blade 16 inboard of the connection point 34. This is because some of the blade loads are diverted to the blade connecting member 36 and connected blades 16 instead of progressing to the hub 18 via the inboard portion 30 of the blade. In particular, loads may be transferred from a higher loaded blade 16 to a lesser loaded blade 16 via a blade connecting member 36 in use. The blade connecting members 36 therefore cause the wind turbine blades 16 to mutually support each other, in the sense that loads on the wind turbine blades 16, such as flapwise loads and in particular edgewise loads, are ‘shared’ across the wind turbine blades 16, via the blade connecting members 36.

Accordingly, the rotor diameter can be extended to increase AEP without requiring an increase in blade root diameter for structural support. The increased blade loading is instead counteracted by the connecting fixtures 32 and associated blade connecting members 36. Accordingly, the blades 16 of the repowered turbine 10 may have a root diameter that is substantially the same as the root diameter of first blades 16a on the existing turbine 10. In many cases, the existing wind turbine 10 may therefore be repowered with a larger rotor 12, without requiring a new hub bearing and/or interface components for connecting the blades 16 to the hub 18.

In some examples, as shown in FIG. 2, the repowering method may additionally include connecting a tension member 38 between each blade connecting member 36 and the hub 18. Each tension member 38 may be configured to apply a tension force pulling the blade connecting member 36 towards the hub 18. The tension members 38 advantageously provide an alternative load path for transferring blade loads to the hub 18, bypassing the inboard portion 30 of the blade 16. Installation of the or each tension member 38 may therefore be particularly beneficial for reducing loads in the inboard portion 30 of each blade 16 following the repowering method.

In such examples, the repowering method may additionally include coupling a tension adjustment system 40 between the tension member 38 and the hub 18 to facilitate adjustment of the tension in the tension member 38 and associated blade connecting member 36. In some examples the tension adjustment system 40 may comprise a linear actuator coupled between each respective tension member 38 and the hub 18. For example, each linear actuator preferably has an adjustable length to facilitate adjustment of the tension in the tension member 38 and associated blade connecting member 36.

For the avoidance of doubt, the repowered wind turbine 10 comprises many of the same components as the initially-described existing turbine 10. Whilst these have not been described again in detail to avoid repetition, it will be appreciated that, in addition to the features of the repowered wind turbine 10 already described above, the repowered wind turbine 10 comprises a nacelle 14, the rotor 12 is rotatably mounted to the nacelle 14, and the nacelle 14 may house the same power generating components as the existing turbine 10. Further, each blade 16 of the rotor 12 comprises a blade shell 20, each blade 16 extends in a radial direction r from a blade root 22 to a blade tip 24 and each blade 16 is connected to the hub 18.

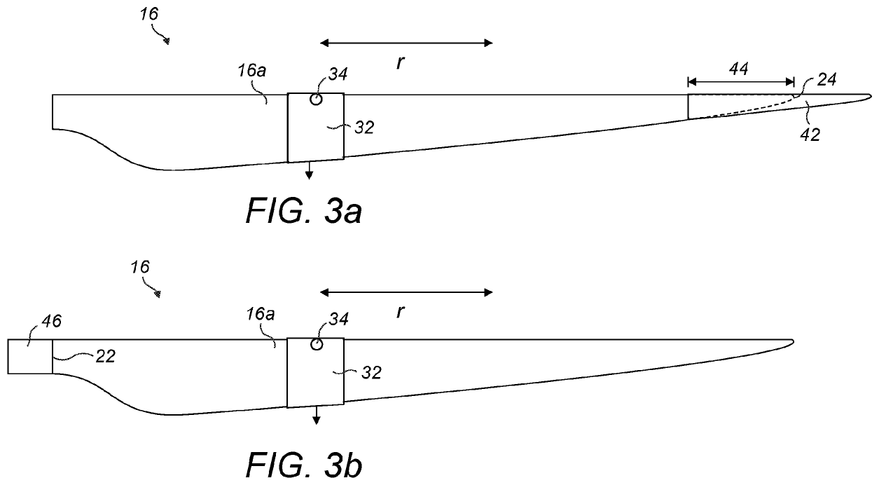

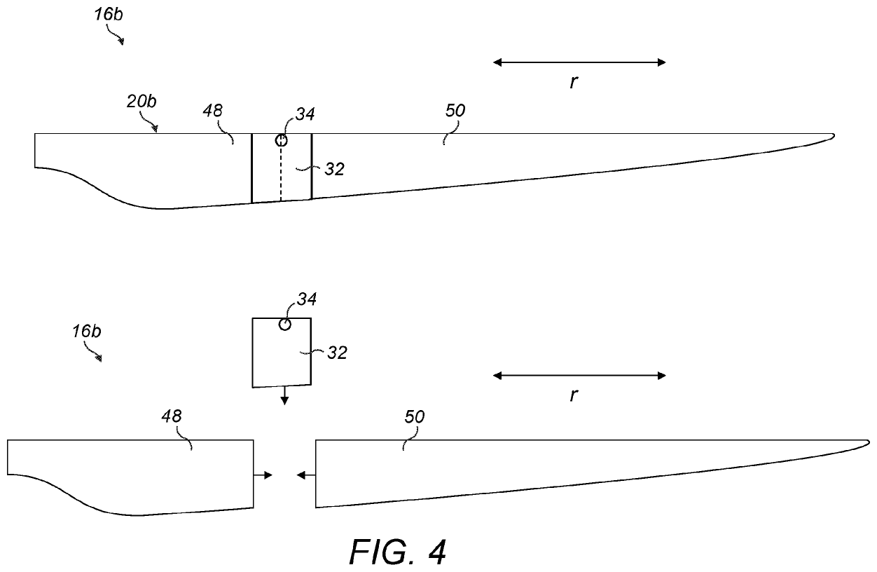

Whilst the method of repowering the wind turbine 10 has been described generally with reference to FIGS. 1 and 2, a plurality of examples of increasing the rotor diameter will now be described with reference to FIGS. 3a to 4.

Referring initially to FIGS. 3a and 3b, the rotor diameter may be increased by extending each used first wind turbine blade 16a in the radial direction r. For example, as shown in FIG. 3a, a tip extension 42 may be attached to each used first wind turbine blade 16a to extend the blade 16a in the radial direction r. For example, the tip extension 42 may comprise a sleeve portion 44 shaped to fit over a tip end 24 of the used first wind turbine blade 16a. Each tip extension 42 may be attached to a respective used first blade 16a up-tower, i.e. whilst the blades 16a and hub 18 remain attached to the nacelle 14 of the turbine 10. However, in preferred examples, each used first blade 16a may be detached from the hub 18 prior to attaching the respective tip extension 42. Following attachment of the tip extension 42, the extended blade 16 may be subsequently reattached to the hub 18.

With reference to FIG. 3b, in some examples, the used first wind turbine blades 16a may be extended by attaching a root extension 46 to the blade root 22 of each used first blade 16a. Accordingly, the method may involve detaching the first blades 16a from the hub 18 and subsequently attaching a root extension 46 to the blade root 22 of each used first blade 16a. The extended blades 16 may be subsequently reattached to the hub 18 via the respective root extension 46, i.e. by attaching the root extension 46 to the hub 18.

Whilst not shown in the accompanying figures, it will be appreciated that in some examples increasing the rotor diameter may involve attaching both a tip extension 42 and a root extension 46 to each used first blade 16a. In each example of attaching a tip and/or root extension 42, 46, the diameter of the rotor 12 is increased such that the AEP of the repowered turbine 10 may be increased compared to the AEP of the existing turbine 10.

Connecting fixtures 32 with connection points 34 are also installed on the wind turbine blades 16 of FIGS. 3a and 3b. When used first blades are used directly or with extended with a tip extension 42 or a root extension 46 it is preferred to use a collar type connection fixture as described below as collar type connection fixtures in many cases may be added to a wind turbine blade 16 without significant modification of load bearing structures of the blade 16.

In some other examples, the rotor diameter may be increased by exchanging each used first wind turbine blade 16a for a second wind turbine blade 16b (shown in FIG. 4). In such an example, the method may comprise providing a plurality of second wind turbine blades 16b that are each longer in the radial direction r than the respective used first wind turbine blades 16a for which they are exchanged. For the avoidance of doubt, it will be appreciated that in such an example, the method involves detaching the first used wind turbine blades 16a from the hub 18 and subsequently attaching the second blades 16b to the hub 18.

An example of a longer second blade 16b is shown in FIG. 4, which shows both a second blade 16b and an exploded view of an example of such a blade 16b. Each second blade comprises a second blade shell 20b. As shown, in some examples the second blade shell 20b may comprise an inboard shell section 48 and an outboard shell section 50 that are connected together to form the second blade shell 20b. Such a configuration may facilitate the reuse of blade shell materials of used blades. For example, at least part of the inboard shell section 48 of the second blade 16b may be formed of at least part of an inboard portion of a used first blade shell 20a. Similarly, in some examples, at least part of the outboard shell section 50 of the second blade 16b may be formed of at least part of an outboard portion of a used first blade shell 20a. A used blade shell may therefore be repurposed and modified to form the inboard and/or outboard shell section 48, 50 of a respective second blade 16b.

It will be appreciated that, whilst not shown in the accompanying figures, such modification may involve cutting a used blade at a given radial location to form an inboard shell section 48 or an outboard shell section 50 of a specified length for the second blade shell 20b. Accordingly, a significant portion of a used blade may be reused to form the respective second blades 16b. Such reuse is both environmentally and financially advantageous.

As shown in FIG. 4, in some examples where the second blades 16b comprise an inboard shell section 48 and an outboard shell section 50, the connecting fixture 32 may be attached to both the inboard shell section 48 and the outboard shell section 50 of the respective second blade shell 20b. In some examples, each second blade 16b may be assembled by connecting the respective inboard and outboard shell sections 48, 50 together via the connecting fixture 32. As such, the connecting fixture 32 may serve a dual purpose of providing a connection point 34 and also connecting the inboard and outboard shell sections 48, 50 together.

Other optional features and steps in the repowering method will now be described with reference to the remaining figures. FIGS. 5, 6 and 7 show different schematic views of a blade 16 of the repowered wind turbine 10. As such, the blade 16 shown in FIGS. 5, 6 and 7 may be a blade 16, 16b such as any of those described with reference to the examples of FIGS. 2, 3a, 3b to 4. It will be appreciated that the following features described with reference to FIGS. 5, 6 and 7 are therefore equally applicable to each of these previously-described examples.

Referring initially to FIG. 5, in some preferred examples, the repowering method may involve attaching each connecting fixture 32 to a respective blade 16 such that the connection point 34 provided by the connecting fixture 32 is located at a radial distance X of between 0.25 R to 0.55 R from the rotor axis A. As used herein, R represents half of the second rotor diameter D2. Accordingly, R may also be referred to as the second rotor radius.

Providing the connection point 34 at a radial distance of between 0.25 R to 0.55 R from the rotor axis A advantageously diverts a significant proportion of blade loads to the or each blade connecting member 36 and away from the inboard portion 30 of the blade 16 of the repowered wind turbine 10. Further a connection point 34 located in this range provides an advantageous compromise between load reduction in the inboard portion 30 of the blade and increased noise and aerodynamic drag resulting from attaching the connecting fixture 32 and associated connecting members 36 in the repowering method.

Whilst not shown explicitly in FIG. 5, the step of attaching a connecting fixture 32 to each blade 16 may involve bonding a connecting fixture 32 to each blade 16 using adhesive. A bonded connection provides a large surface area over which to transfer loads between the blade shell 20 and connecting fixture 32 in use. In some examples, a plurality of fixing members (not shown) may be used to attach each connecting fixture 32 to a respective blade 16. For example, the fixing members may extend into the blade shell 20. This may provide additional security for attaching the connecting fixture 32 to the blade 16, and may provide additional load paths for transferring loads between the blade shell 20 and the connecting fixture 32.

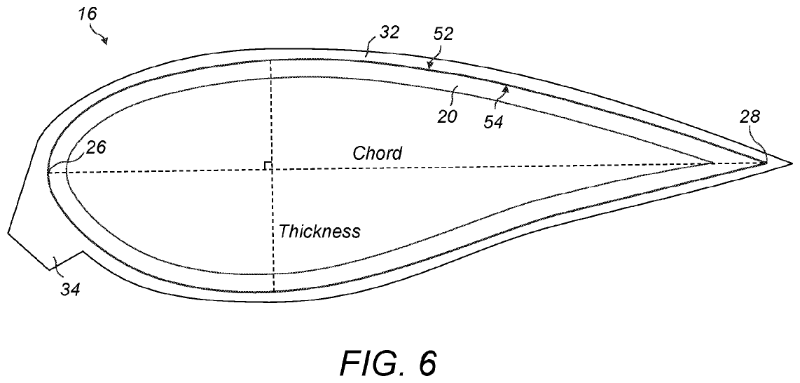

With reference still to FIG. 5, and with brief reference additionally to the cross-sectional view shown in FIG. 6, each blade 16 comprises a chord length which is the length between the leading edge 26 and the trailing edge 28 at any given radial location. It will be appreciated that the chord length varies along the radial length of the blade 16 due to the varying aerodynamic profile of the blade 16.

In preferred examples, such as those shown in the accompanying figures, each connecting fixture 32 is preferably configured with a length/of between 0.5 C and 1.5 C, where C is the chord length at the connection point 34. Accordingly, each connecting fixture 32 preferably extends over a radial extent of between 0.5 C and 1.5 C. With this configuration, the connecting fixture 32 has an advantageous surface area to attach to the blade shell 20. Additionally, in some examples this may allow the formation of an advantageous tapered outer surface of the connecting fixture 32 to provide a smooth aerodynamic transition from the blade shell 20 to the connecting fixture 32.

FIG. 6 shows a cross sectional view of an example of a connecting fixture 32 attached to the blade shell 20. In preferred examples, such as those shown in the accompanying figures, each connecting fixture 32 comprises an inner profile 52 shaped to substantially match an outer profile 54 of the blade shell 20 to which the fixture 32 is attached. This helps to distribute loads over a large surface area to avoid load concentrations when transferring loads between the blade shell 20 and connecting fixture 32 in use. Additionally, substantially matching the inner profile 52 of the connecting fixture 32 to the blade shell profile 54 may simplify accurate arrangement of the connecting fixture 32 on the blade shell 20.

As shown in FIG. 6, in some examples the connecting fixture 32 may extend around a leading edge 26 of the blade 16. Such a configuration facilitates the provision of one or more connection points 34 near to the leading edge 26 of the blade 16, i.e. within a distance of 0.5 C from the leading edge 26 (e.g. in front of or behind the leading edge 26). Locating a connection point 34 in this region is particularly advantageous for reducing pitch loads in use, and also for minimising the risk of a blade connecting member 36 clashing with the blade shell 20 when pitching the blade 16 of the repowered turbine 10 in use.

Referring still to FIG. 6, the connecting fixture 32 may, in some examples, extend around and enclose, i.e. surround, the portion of the blade shell 20 to which the fixture 32 is attached. As such, the connecting fixture 32 may be configured as a collar around the blade shell 20. Such a configuration may provide particularly secure attachment of the connecting fixture 32 to the blade shell 20. Further, this configuration may provide an advantageous large joint area for transferring loads between the blade shell 20 and connecting fixture 32 in use. A collar configuration may be particularly advantageous in examples where the connecting fixture 32 spans a joint between inboard and outboard blade shell sections 48, 50 of a second wind turbine blade 16b, because the additional joint area afforded by this configuration may add strength to the joint between shell sections 48, 50. The connecting fixture 32 may comprise a plurality of parts which, when attached to the blade 16 form a connecting collar that extends around and encloses the portion of the blade shell where the connecting fixture 16 is attached. For example, the fixture may comprise a windward part and a leeward part configured respectively for attachment to a windward side and a leeward side of the blade shell. The windward and leeward parts of the connecting fixture 32 may meet at respective joints at the leading edge and trailing edge of the blade shell to form the connecting collar. In such an example, the method may comprise overlaminating the leading edge and trailing edge joints of the connecting fixture to form a smooth outer surface.

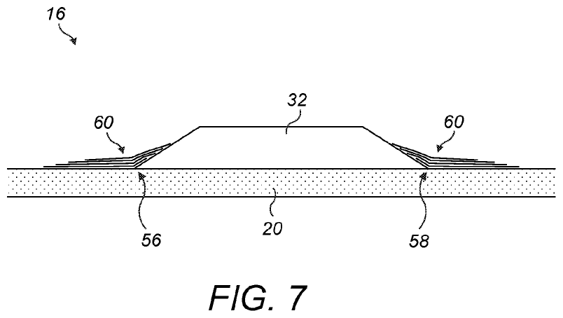

With reference now to FIG. 7, in some examples attaching the connecting fixture 32 to a respective blade 16 may additionally involve overlaminating one or both of an inboard edge 56 of the connecting fixture 32 and/or overlaminating an outboard edge 58 of the connecting fixture 32. For example, one or more layers of reinforcing material 60 may be laminated over the inboard edge 56 of the connecting fixture 32 when the connecting fixture is arranged on the blade shell 20. Similarly, one or more layers of reinforcing material 60 may be laminated over the outboard edge 58 of the connecting fixture 32. This overlamination may help to provide a stronger connection between the connecting fixture 32 and the blade shell 20. Further, in some examples the overlaminated layers of reinforcing material 60 may advantageously smooth the transition between the blade shell 20 and connecting fixture 32, thereby reducing aerodynamic drag.

It will be appreciated that the description provided above with reference to the accompanying figures is provided by way of example only. Further, it should be understood that any feature described with reference to a particular example and/or figure may be equally applicable to any other example described herein. Additionally, it will be appreciated that some examples of the present invention are not shown in the figures.

For example, as described previously, the method of repowering the wind turbine 10 may include connecting a tension member 38 and/or tension adjustment system 40 between each blade connecting member 36 and the hub 18. Such examples may further include modifying the hub 18, for example by installing connectors for connecting the tension members 38 and/or tension adjustment system 40 to the hub 18. In some examples this may involve installing a support structure extending from the hub 18 in an upwind direction such that the connectors are provided upwind of the hub 18. Such a configuration could help reduce flapwise loading in the inboard portion 30 of the blades 16 because the tension members 38 and blade connecting members 36 have a tension component that effectively pulls the blades 16 in a slightly upwind direction. This may also be advantageous for reducing the risk of the longer blades 16 of the repowered turbine 20 striking a tower 62 of the turbine 10 in high wind conditions.

Further, whilst the example of a second blade 16b shown in FIG. 4 comprises an inboard shell section 48 and an outboard shell section 50, it will be appreciated that in some examples each second blade 16b may simply be a second blade 16b that is longer in the radial direction r than the used first blade 16a. For example, the second blade 16b may comprise a single shell section that extends from the blade root 22 to the blade tip 24. In some examples, the second blade 16b may be a new blade, i.e. an unused blade, that is radially longer than the used first blade 16a. Alternatively, in some examples the second blade 16b may be a used second blade, i.e. a used blade from a different turbine, which is longer than the used first blade 16a. In each of these examples, and as previously described above, each second blade 16b preferably has a root diameter that is substantially the same as the root diameter of the used first blade 16a for which it is exchanged.

Further, also in relation to the provision of a plurality of second blades 16b, in the example described with reference to FIG. 4, each second blade 16b comprises an inboard section 48 defining the blade root 22, and an outboard section 50 defining the blade tip 24. However, it will be appreciated that the inboard and outboard shell sections 48, 50 are defined relative to one another and the rotor axis A. That means that the inboard shell section 48 is inboard of the outboard shell section 50 relative to the rotor axis A, and accordingly the outboard shell section 50 is outboard of the inboard shell section 48, relative to the rotor axis A. As such, in some examples (not shown) the inboard shell section 48 may not define the blade root 22 of the second blade 16b. Additionally or alternatively, in some examples the outboard shell section 50 may not define the blade tip 24 of the second blade 16b. Accordingly, the inboard and/or outboard blade shell section 48, 50 may be an intermediate shell section defining at least part of a central portion of the shell between the blade root 22 and blade tip 24 of the second blade 16b.

Whilst not shown in the accompanying figures, in each of the examples described herein, the method may additionally include upgrading a controller of the wind turbine 10. For example, the existing wind turbine 10 may include a controller configured to control various functions of the wind turbine 10. As part of the repowering method, in some examples it may be advantageous to upgrade at least one of the control functions of the controller. In particular, the controller may be upgraded to ensure safe operation of the wind turbine 10 despite the increase in rotor diameter.

For example, the controller may be upgraded with a revised control function to reduce the rated rotational speed of the rotor 12. Accordingly, despite the increased rotor diameter, and therefore the increased distance of the blade tip 22 from the rotor axis A, the tip velocity of the repowered wind turbine 10 may be maintained at the same or less than that of the original turbine 10. In such an example, the repowering method may therefore not lead to an increase in noise, which may be particularly advantageous for repowering on-shore wind turbines 10.

In some examples, the controller may be upgraded with revised control functions to reduce the rated power of the repowered turbine 10 and/or reduce the stop wind speed of the repowered turbine 10 to ensure safe operation.

Further, the controller may be upgraded with a revised control function to modify the pitch control of the repowered wind turbine 10. For example, the pitch control may be modified to change the wind speed thresholds at which pitching occurs. Accordingly, the repowered wind turbine 10 may pitch the blades 16 to limit flapwise blade loads. Pitching the blades 16 in accordance with the revised control function may also advantageously limit the maximum thrust on the turbine 10.

Further, the controller may be upgraded control software introducing or modifying cyclic and/or individual pitch control as load reduction feature. This is particularly advantageous when the repowered wind turbine include tension members with linear actuators as these features may facilitate and improve efficiency of cyclic and individual pitch control for the wind turbines.

In some examples, the method of repowering the wind turbine 10 may involve arranging one or more shim angle adjustment members (not shown) between the root 22 of each blade 16 and the hub 18. Accordingly, each blade 16 may be connected to the hub 18 via one or more shim angle adjustment members. The shim angle adjustment members are preferably configured to change the inclination of the blade 16 relative to a pitch axis of the blade 16 in a plane perpendicular to the rotor plane (out of plane shim angle) and/or relative to the pitch axis in a plane parallel to the rotor plane (in plane shim angle). As an example, one or more shim angle adjustment members may be arranged to increase the out of plane shim angle to reduce the risk of longer blades 16 striking the tower 62 in high wind conditions in use.

Reference to the inclination of the blade 16 should be understood to refer to an angle defined between the specified reference and a theoretical centre line of the blade 16. As used herein, the theoretical centre line of the blade 16 connects a centre point of the blade root 22 and a blade centre at the radial location of the connection point 34 (where the blade centre is defined as the intersection of the chord between the leading and trailing edges 26, 28 and a thickness line orthogonal to the chord at the maximum thickness, at the given radial location).

Further, whilst not shown in the accompanying figures, some examples of increasing the rotor diameter may involve providing a hub extender between the hub 18 and each blade root 22. Accordingly each blade 16 of the repowered wind turbine 10 may be connected to the hub 18 via the hub extender. A hub extender may be used in combination with any of the examples described herein to increase the diameter of the rotor 12 to facilitate the capture of more energy from the incident wind. A hub extender may also be used to adjust in plane shim angle and/or out of plane shim angle and/or adapt the blade diameter and/or bolt arrangement of the blade root to the hub.

It will be appreciated that the description provided above serves to demonstrate a plurality of possible examples of the present invention. Features described in relation to any of the examples above may be readily combined with any other features described with reference to different examples without departing from the scope of the invention as defined in the appended claims.

1. A method of repowering a horizontal-axis wind turbine, the wind turbine comprising a rotor rotatably mounted to a nacelle, the rotor comprising a plurality of used first wind turbine blades connected to a hub, each blade comprising a blade shell, and each blade extending in a radial direction from a blade root to a blade tip and in a chordwise direction between a leading edge and a trailing edge, and the rotor defining a rotor axis and a first rotor diameter, the method comprising:
increasing the rotor diameter such that the rotor defines a second rotor diameter that is greater than the first rotor diameter;
attaching a connecting fixture to each blade, each connecting fixture defining a connection point for connecting a blade connecting member to the blade; and
connecting a blade connecting member between corresponding connection points of a pair of wind turbine blades such that each blade is connected to at least one other blade by a blade connecting member.

2. The method of claim 1 wherein increasing the rotor diameter comprises:
a) extending each used first wind turbine blade in the radial direction; or
b) providing a plurality of second wind turbine blades and exchanging each used first wind turbine blade for a second wind turbine blade, wherein each second wind turbine blade is longer than each first wind turbine blade in the radial direction.

3. The method of claim 2, wherein extending each used first wind turbine blade in the radial direction comprises attaching a tip extension to each first wind turbine blade.

4. The method of claim 2, wherein extending each used first wind turbine blade comprises attaching a root extension to the blade root of each first blade.

5. The method of claim 2, wherein each second blade comprises a second blade shell comprising an inboard shell section and an outboard shell section connected together, and
wherein at least part of the inboard shell section is formed of at least part of an inboard portion of a used first blade shell, and/or
at least part of the outboard shell section is formed of at least part of an outboard portion of a used first blade shell.

6. The method of claim 5, wherein attaching the connecting fixture to each blade comprises attaching the connecting fixture to both the inboard shell section and the outboard shell section of the respective second blade shell.

7. The method of claim 1, wherein increasing the rotor diameter comprises providing a hub extender between the hub and each blade root.

8. The method of claim 1, wherein the connecting fixture is a retrofitted connecting fixture.

9. The method of claim 1, wherein the connecting fixture extends over a radial extent of between 0.5 C and 1.5 C, where C represents the chord length of the blade at the connection point.

10. The method of any preceding claim, wherein attaching a connecting fixture to each blade comprises bonding a connecting fixture to each blade using adhesive.

11. The method of claim 1, wherein attaching a connecting fixture to each blade comprises attaching the connecting fixture to the blade using a plurality of fixing members that extend into the blade shell.

12. The method of claim 1, wherein each connecting fixture is attached to a respective blade such that the connection point is located at a radial distance of between 0.25 R to 0.55 R from the rotor axis, where R represents half of the second rotor diameter.

13. The method of claim 1, wherein attaching the connecting fixture to a blade comprises overlaminating an inboard edge of the connecting fixture and/or overlaminating an outboard edge of the connecting fixture.

14. The method of claim 1, further comprising detaching each used first wind turbine blade from the hub before increasing the rotor diameter.

15. The method of claim 1, further comprising arranging one or more shim angle adjustment members between the root of each blade and the hub to change an in-plane inclination and/or out-of-plane inclination of each blade.

16. The method of claim 1, wherein the wind turbine comprises a controller, and wherein the method further comprises upgrading the controller with one or more revised control functions to effect at least one of the following:
a) reduce the rated rotational speed of the rotor;
b) reduce the rated power of the wind turbine;
c) modify the pitch control to limit the maximum thrust on the wind turbine and/or to limit flapwise blade loads;
d) reduce the stop wind speed;
e) modify pitch control by introducing or modifying cyclic and/or individual pitch control as load reduction feature.

17. A horizontal-axis wind turbine comprising:
a rotor rotatably mounted to a nacelle, the rotor comprising a plurality of wind turbine blades connected to a hub, each blade comprising a blade shell, and each blade extending in a radial direction from a blade root to a blade tip; wherein each blade is a repowered blade comprising one or more blade extension segments configured to be attachable and detachable to selectively increase and decrease, respectively, a rotor diameter of the rotor;
a connecting fixture attached to each blade, each connecting fixture defining a connection point for connecting a blade connecting member to the blade; and
a plurality of blade connecting members, each blade connecting member being connected between corresponding connection points of a pair of wind turbine blades such that each blade is connected to at least one other blade by a blade connecting member.

18. The horizontal-axis wind turbine according to claim 17, wherein the connecting fixture is a retrofitted connecting fixture.

19. The horizontal-axis wind turbine according to claim 17, wherein the respective shell of each blade includes coupling features configured to attach the respective blade extension segments.
